(19) United States
(12) Patent Application Publication
(10) Pub. No.: US 2002/0095405 A1
(43) Pub. Date: Jul. 18, 2002

(54) View definition with mask for cell-level data access control

(75) Inventor: Shinji Fujiwara, Cupertino, CA (US)

Correspondence Address: George B. F. Yee, TOWNSEND and TOWNSEND and CREW LLP, 8th Floor, Two Embarcadero Center, San Francisco, CA, 94111-3834, US

(73) Assignee: Hitachi America, Ltd.

(21) Appl. No.: 09/765,790

(22) Filed: Jan. 18, 2001

(51) Int. Cl. G06F 7/00

(52) U.S. Cl. 707/3

(57) ABSTRACT

We propose an extension of the view function, called a view with mask, where we can define a mask condition and values for each column that will be applied to the result of query execution. We also provide a set of query rewrite algorithms to implement a view with mask. Then, we define semantics for a selection condition on mask columns, an aggregation on mask columns, and external references for mask conditions. A view with mask can keep a security level, called inference-free against coloring, i.e., if an initial relation is inference-free against coloring, then a result of a query on the relation is also inference-free against coloring.

### BACKGROUND OF THE INVENTION

The present invention relates generally to database access and in particular to controlled access to fields in a database.

Today's information technology enables one to experience seamless access to various kinds of data sources. Such technology makes accessible to people increasingly greater amounts of information. However, data sources often contain critical information such as medical records, financial records, and other similar personal information which should be protected from unauthorized access, requiring access privilege of those who desire to access such information. Database systems have evolved to provide a set of data access control functions using view definitions and authorization models.

A view is an information object that allows you to view data in a normal table, but in a different way. It is a logical dynamically defined table comprised of portions of the fixed tables which constitute the database. Views provide a method for looking at data in the underlying tables without having to duplicate the data.

The traditional view can control access to data in the database on either a row-level and/or a column level basis. FIG. 1 shows an example of hospital data INPT_BASE 100 that contains inpatient information and aggregated inpatient information grouped by MD_ID. Assume that each physician is permitted only to see his/her patient visit. FIG. 2 shows the desired views of INPT_BASE 100 for each physician. The PT_ID, VST, P_NM and MD_ID fields are selectively made invisible to protect the privacy of each patient so physicians can only see data for their own patients. Thus, for the doctor whose ID is 2222, the view that should be available to that doctor is the view 202. For the doctor whose ID is 3333, the view is view 204.

A view for the inpatient table can be defined by a conventional view definition (or view creation). For example, FIG. 3 shows a view definition that produces the views 202, 204, 206 shown in FIG. 2. (Note that user-id can be replaced with an expression that returns the current user-id, e.g., SYS_CONTEXT(‘userenv’, ‘session_user’), in the case of an Oracle database system.) However, if we execute the SQL statement in FIG. 4 to get the aggregated inpatient information grouped by MD_ID, each physician will get different results such as shown in FIG. 5.

To get the desired aggregation result shown in FIG. 2, we can define a view shown in FIG. 6. However, we must define all possible combinations of aggregation views to allow ad-hoc multi-dimensional analysis. This brute force approach greatly increases the view maintenance cost significantly. For example, if a physician wants to see the statistics of specific a DRG (Diagnostic Related Group) e.g., DRG BETWEEN 120 and 129, then we must define a view that aggregates the subset of data grouped by MD_ID separately. Since each physician may want to see a different subset of data, it is almost impossible to prepare this view beforehand.

Current systems solve this issue by implementing access-control policies as a part of the application logic. However, there are multiple applications in a typical system. Consequently, an access policy would have to be implemented in each of the different applications, a task which significantly increases the maintenance cost of the access policy. In cases where legacy software is being used, the effort may be frustrated completely.

Database protection can be obtained through a variety of security measures including: flow, inference, and access control. Access controls in information systems are responsible for ensuring that all direct access to the system object occurs exclusively according to the models and rules fixed by protection policies. Access controls are enhanced to a content-dependent access control model for database systems. In the conventional view definition based on content-dependent access control model, an access rule can be represented by the tuple (s, o, t, p), which specifies that a subject s has access t to those occurrence of object o for which predicate p is true. An enhancement of the model comprises a six tuple (a, s, o, t, p, f), where a is an authorizer subject who granted s the right (o, t, p), while f is a copy of a flag describing the possibility for s to further transfer (o, t, p) to other objects.

Many security models have been proposed in the prior art literature. The Access Matrix model, Take-Grant model, Action-Entity model, and Wood et al. model are discretionary security models. A user query is checked against the authorizations. If it is allowed, the query accesses the object in a specific access mode. Otherwise the access is denied.

In a paper by Lunt, T. F., Denning, D., Schell, R. R., Heckman, M., and W. R. Shockley, entitled “The SeaView Security Model,” IEEE Trans. on Software Engineering, Vol. 16, No. 6 (June 1990), pp. 593-607, a security model known as the Sea View model was proposed to protect security of relational database systems by using two layers: Mandatory Access Control (MAC) model and Trusted Computing Base (TCB) model. Sea View controls multilevel data access by generating virtual multi-level relation instances from physical single-level relations.

Other models include Jajodia-Sandhu's model and Smith-Winslett's model which have been proposed as multilevel security models. Security policies for these models generate virtual multi-level relation instances. These models use a commutative filter that is placed between a database system and applications to implement database security.

Processing a conventional view includes the following typical steps:

1) Authentication.

2) Apply view definitions, i.e., rewrite a query according to view definitions.

3) Optimize the query.

4) Execute the query.

5) Return results.

In the conventional view, access control rules are applied to a query before execution. The query cannot access a column that is not a member of the projection columns. Furthermore, if a user defines a function that blinds the column value as a projection object, the query cannot access the original value either.

Ferraiolo, David F., Barkley, John F., and Kuhn, D. Richard, in a paper entitled “A Role-Based Access Control Model and Reference Implementation Within a Corporate Intranet,” Trans. Inf. Syst. Secur. 2, 1 (Febuary 1999), pp. 34-64, describe a rolebased access control that gives access privileges based on the concept of user-roles.

The Oracle 8i system has a fine-grain access control using a virtual private database, which is discussed in a white paper by Davidson, Mary A., entitled “Creating Virtual Private Databases with Oracle8i,” Oracle Magazine, (July 1999). This function enables a database designer to add a selection condition string automatically whenever a user accesses the table. The condition string can be generated based on any value, e.g., context values and session values. However, the condition eliminates the rows that do not satisfy it, and so we cannot mask a subset of the columns in a row.

A security model has been proposed for statistical database systems to prevent statistical inference, in a paper by Chin, F. Y., entitled “Security in Statistical Databases for Queries with Small Counts,” ACM Trans. Database System, 3, I (March 1978), pp. 92-104. There are three techniques for inference protection, i.e., conceptual, restriction-based, and perturbation-based techniques, see for example “Database Security,” by Castano, Silvana, Fugini, Mariagrazia G., Martella, Giancarlo, and Samarati, Pierangela, Addison-Wesley Publishing Company, (1994) and a paper by Adam, Nabil R. and Worthmann, John C., entitled “Security-control Methods for Statistical Databases: A Comparative Study,” ACM Comp. Surveys, Vol. 21, No. 4, (December 1989), pp. 515-556. These techniques suppress the statistical values or restrict a combination of group dimensions. However, the techniques do not provide a function that suppresses a dimension value itself. Therefore, they cannot define an access policy for aggregation results such as shown in FIG. 2.

There is a need for a fine grain flexible cell-level data access control technique based on access policy. It is desirable to provide an access policy that facilitates operations such as DEFINE, CHANGE, and DELETE. It is desirable to provide a technique which has no impact on existing application logic (code), preferably within a database system or as middleware.

### SUMMARY OF THE INVENTION

According to the present invention, provisioning for a view with mask for cell-level data access control includes a new function, a view with mask, and a syntax/semantics that can be implemented as an extension of the conventional view definition. A query rewrite algorithm implements the mask functions so as to be easily integrated with pre-existing database systems. The rewrite takes into consideration selection conditions on mask columns including JOIN, HAVING, ORDER BY operations, and so on. For aggregation functions, there are aggregation mask conditions that can mask the aggregation result based on the condition of the source data set. Semantics of a view with mask for a query that has subqueries are also provided.

### BRIEF DESCRIPTION OF THE DRAWINGS

The teachings of the present invention can be readily understood by considering the following detailed description in conjunction with the accompanying drawings:

FIG. 1 illustrates an example of a data organization for hospital-related data;

FIG. 2 illustrates the views of the data shown in FIG. 1, typically required by physicians;

FIG. 3 shows a view definition which produce the views shown in FIG. 2;

FIG. 4 shows a SQL statement with aggregation;

FIG. 5 shows the result of an aggregation inquiry on a view defined by a conventional view definition;

FIG. 6 shows a prior art view definition with aggregation;

FIG. 7 shows an illustrative example of a view definition in accordance with the invention;

FIGS. 8a and 8b illustrate a comparison of a view produced by a conventional view definition versus a view produced in accordance with the invention;

FIG. 9 shows an illustrative example of a translated SQL statement produced in accordance with the invention;

FIGS. 10a and 10b illustrate embodiments of the invention as middleware;

FIG. 11 illustrates the view with mask definition in terms of a syntax diagram;

FIG. 12 illustrates an example of a view with mask definition according to the invention;

FIGS. 13a and 13b illustrate the result of the translation process according to PROCESS 1;

FIGS. 14a -14c illustrate how a selection condition can “break” a mask;

FIG. 15 shows how the condition shown in FIGS. 14a -14c is avoided according to translation PROCESS 2;

FIG. 16 illustrates a selection condition containing a join operation which can “break” a mask;

FIGS. 17 and 18a -18c show a situation which requires the use of a JOIN operation;

FIG. 19 shows the use of join permissions with a JOIN operation;

FIG. 20 illustrates group-by mask columns;

FIGS. 21a -21d illustrate translations of view definitions with an aggregate mask condition;

FIG. 22 shows a view definition with an aggregate mask condition;

FIG. 23 shows aggregation on a view with mask;

FIG. 24 shows the resulting translated SQL statement of FIG. 23 in accordance with PROCESS 5;

FIG. 25 shows a normalized view of the table shown in FIG. 23a;

FIG. 26 illustrates view definitions having external column references;

FIG. 27 is a syntax diagram for an external column reference;

FIG. 28 illustrates an example of a successful unification of an external column reference;

FIGS. 29 and 30 illustrate examples of failed unification of an external column reference;

FIG. 31 illustrates alternate semantic for external column reference;

FIG. 32 illustrates a query comprising a subquery; and

FIG. 33 shows an example of a component configuration of a database system according to the invention.

### DESCRIPTION OF THE SPECIFIC EMBODIMENTS

To implement a cell-level access control function in a database system in accordance with the present invention, we propose a novel extension of the conventional view, called a view with mask. An access rule is represented by a tuple (s, o, t, p, m), which specifies that m is a set of mask conditions that will be applied after the execution of the query, where a subject s has access t to those occurrence of object o for which predicate p is true.

A mask condition m is represented by a tuple (mc, mv, mp), where mc is a set of columns to be masked and mv is a mask value that will be used instead of the original value when mask predicate mp is false. The predicate mv is defined as an expression so that we can use variable masked values using user functions. We can define role-based mask control using mp. For example, we can set a mask on a column of a physician's name such that any executive can see all names, while a physician could see only his/her name. A table may have different mask conditions for each column.

FIG. 7 shows an example of a view definition 700 in accordance with the invention which produces a view with mask. There is a mask clause 702 which comprises a mask column declaration clause 704 and a mask condition clause (mask predicate, ) 706. The mask column declaration clause comprises a list of column names 711 (mc) and corresponding mask-values 713 (mv). The mask condition clause (mp) represents the condition wherein the column value is visible when the condition evaluates to TRUE. In the example view definition of FIG. 7, the query produces NULL's for the fields PT_ID, VST, P_NM, and MD_ID when MD_ID is not equal to user_id (i.e., when the mask condition is FALSE). When the condition is TRUE (i.e., MD_ID=user_id) then, the fields contain data taken from the database. Thus, when the condition is FALSE, the values associated with the column names 711 listed in the mask column declaration clause 704 are replaced by the corresponding mask-values 713.

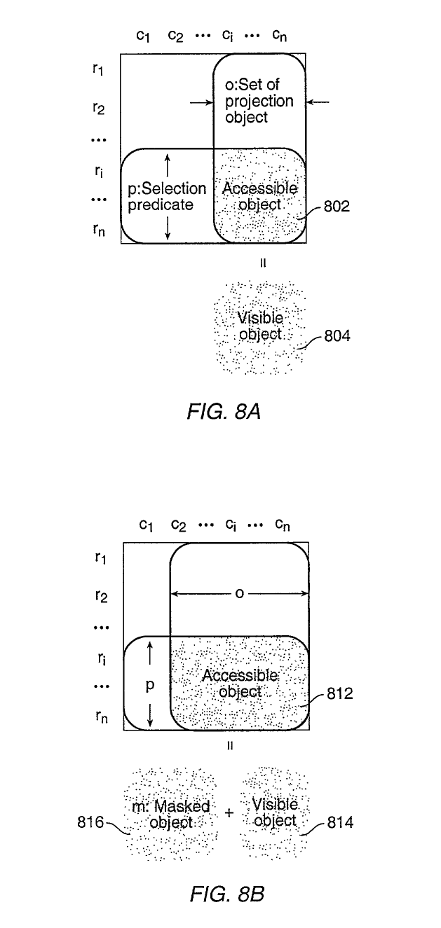

FIG. 8a shows a view produced by conventional view definitions. A conventional view can restrict the data access by selection predicate p and projection objects o. The accessible data object 802 is exactly the same as the visible data 804. By comparison, an enhanced view in accordance with the invention, called view with mask is shown in FIG. 8b. Here, the accessible data object 812 comprises two data objects: visible data 814 and invisible (or masked) data 816.

In accordance with an embodiment of the present invention, a query on a view with mask definition (i.e., includes a mask condition m) is processed as follows:

(1) Authentication.

(2) Apply view definitions, i.e., rewrite a query according to view definitions.

(3) Optimize the query.

(4) Execute the query.

(M) Mask column values and/or filter rows based on mask conditions.

(5) Return results.

A new step (M), occurring between steps (4) and (5), makes it possible to mask column values mv based on the mask conditions mc. Since a user query is executed before the step of masking column values, JOIN and GROUP BY operations have access to the data needed to produce the desired result. Step (4) produces a first (intermediate) result. Step (M) filters the first result based the mask conditions contained in the view with mask definition to produce a final result, which is then returned in Step (5).

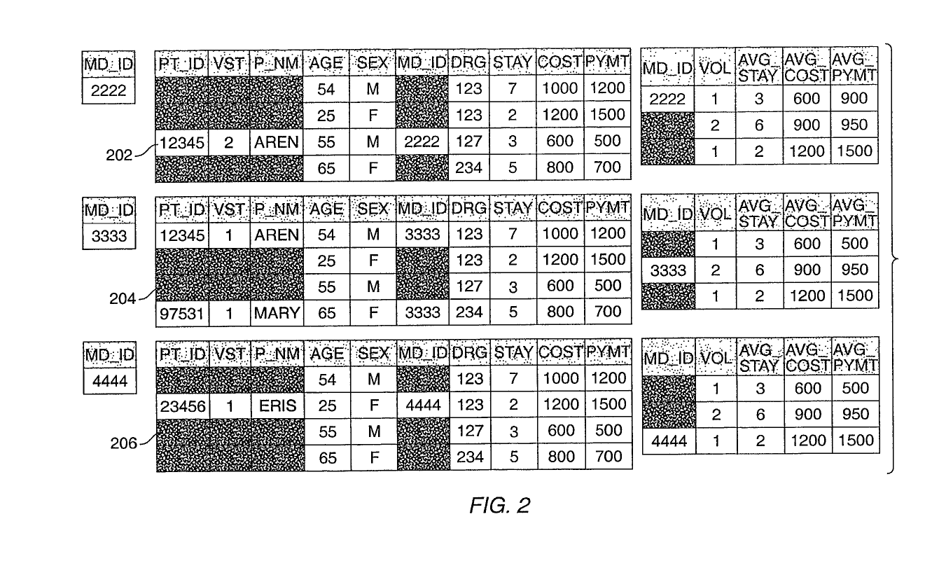

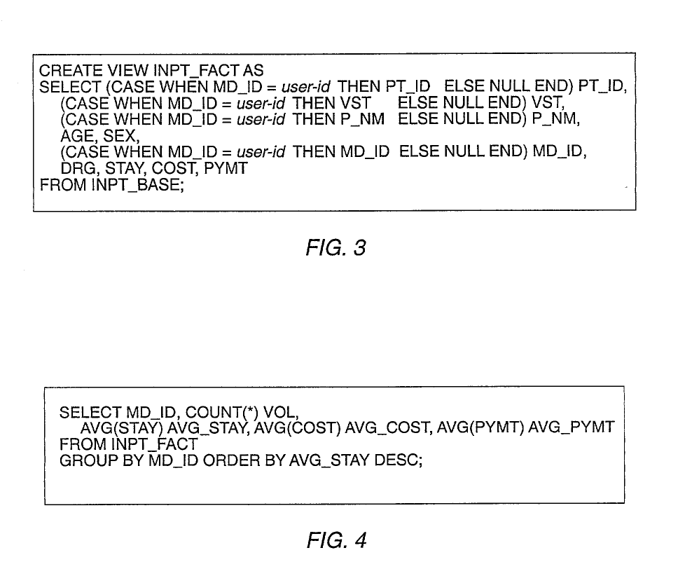

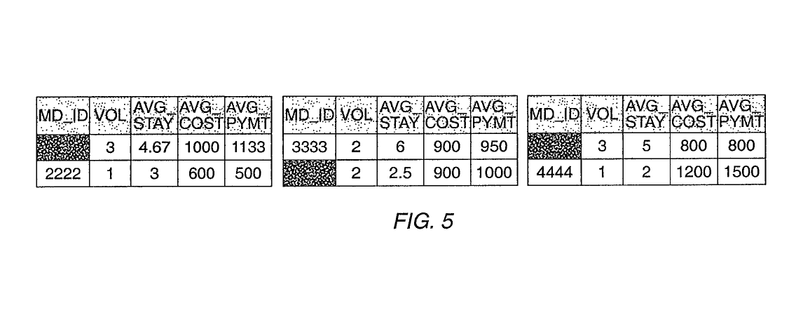

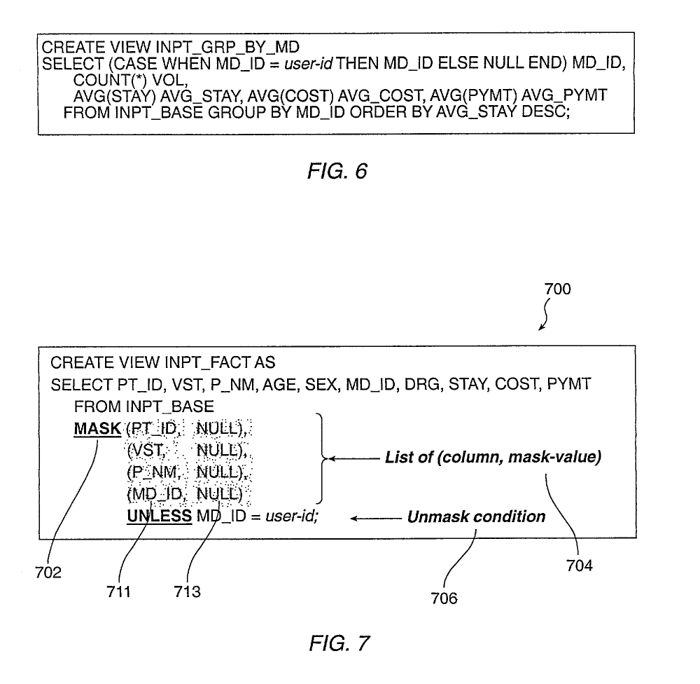

Therefore, we can get an aggregation result such as shown in FIG. 2 without having to define a specific view for each aggregation query. However, this embodiment of the invention requires at least modifications of the existing target database system software in order to recognize a view with mask definition.

According to another embodiment of the present invention, we disclose a query rewrite algorithm for translating an SQL statement according to a view with mask. The query rewrite algorithm of the present invention greatly facilitates its incorporation into an existing database system because the translated SQL statement is based on the native query language of the target database. Consequently, there is no need to affect the target database system.

In accordance with this embodiment of the invention, processing proceeds in the following manner:

(1) Authentication.

(R) Rewrite the query according to mask definitions.

(2) Apply view definitions, i.e., rewrite a query according to view definitions.

(3) Optimize the query.

(4) Execute the query.

(5) Return results.

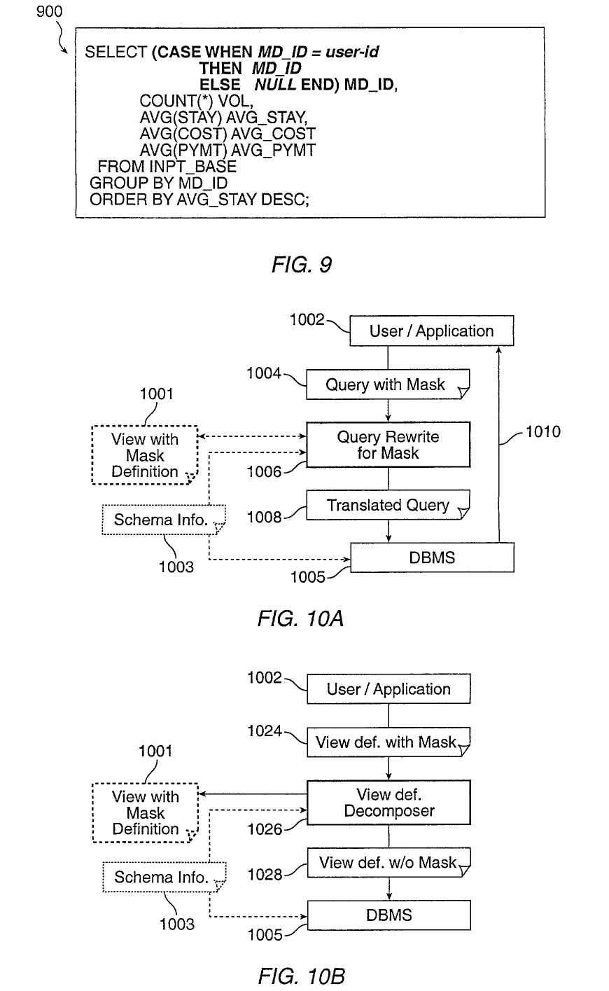

A new step (R) replaces the step (M) discussed in the foregoing embodiment. Step (R) can be implemented as an extension of the conventional view module. Therefore, the implementation cost is much less than in the in foregoing approach. We can also implement a view with mask as middleware. We only have to implement a query translator that rewrites a user query based on the mask conditions, using the native query language of the target database. For example, the SQL statement illustrated in FIG. 4 can be translated into the SQL statement 900 shown in FIG. 9, that can then be executed by the target database system.

FIGS. 10a and 10b show an illustrative example of an embodiment of the invention of a view with mask as middleware, i.e., as a commutative filter. Fig. 10a shows how to process a query that has access to a view with mask. A user or an application 1002 issues a query 1004 which contains a view with mask definition. A middle-tier module 1006 rewrites the query according to the definition 1001 of a view with mask, using schema information 1003 provided by an underlying convention database system 1005. The middle-tier module issues a translated query 1008 to the database system, a result 1010 for which is returned to the user.

FIG. 10b illustrates an example of an embodiment of the invention to execute a view definition with mask 1024. The view definition with mask is decomposed into a pure view definition and a definition of mask by a decomposer 1026. This middle-tier module 1026 obtains the schema information 1003 related to the view from the database system 1005, and checks whether the definition is valid or not. Then, it extracts mask definitions and stores as a view with mask definition 1028.

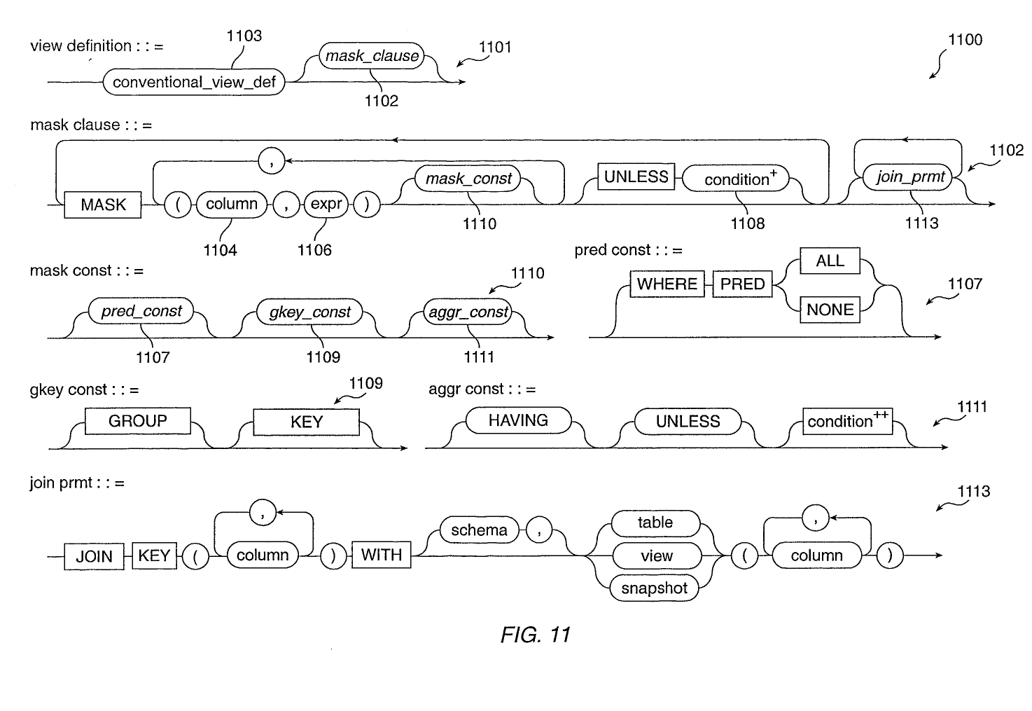

FIG. 11 shows an illustrative example of a syntax diagram 1100 to implement a view with mask. A mask_clause 1102 is added after the conventional view definition 1104. The mask_clause comprises a list of a mask column (column) 1104 and mask value (expr) 1106, with a mask condition (condition⁺) 1108. Note that we can define a mask on an expression that has an alias. Aliases are processed in the same way as columns. Users can use an external column reference to define a mask condition, hence the “⁺” symbol on the condition. The detail of the external column reference is discussed below.

There are optional clauses, i.e., a mask_const 1110 and a join_prmt (join permission) 1103. The mask_const consists of a predicate constraint 1107, a group key constraint 1109, and an aggregation constraint 1111. The detail of the predicate, group key, and the aggregation constraints will be discussed below. The join_prmt 1113 defines explicitly which key can be used as a join key. The join permission will be discussed below.

The discussion will now turn to a description of a query rewrite method according to the invention. We will also define security classes, i.e., inference-free and inference-free against coloring, and briefly show that query rewrite algorithms preserve these security classes.

The following steps outline how to rewrite a simple query that has no aggregation on mask columns.

Process 1

(1) For each mask column mc whose mask value is mv and whose mask condition predicate is mp, apply (2).

(2) Replace each mask column mc with the following CASE expression: (CASE WHEN mp THEN mc ELSE mv END) [mc]

Note that the alias declaration mc is not necessary if mc is used in an expression. A CAST function may be needed in some cases to adjust the data type for the column. Though we do not put the CAST function in this discussion, it is understood that the function can be easily incorporated.

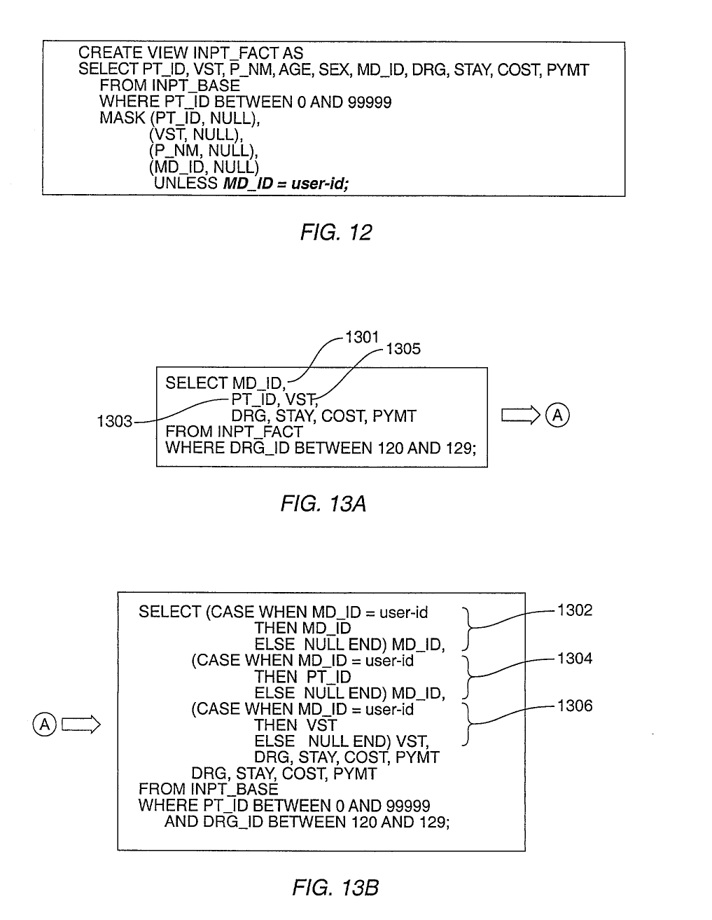

Referring to FIGS. 12, 13a, and 13b an example of a query rewrite according to the foregoing steps is shown. FIG. 12 shows an illustrative example of a view with mask definition which produces a view with mask INPT_FACT of the database shown in FIG. 2. A conventional query such as the one exemplified in FIG. 13a would be translated per PROCESS 1 to produce a translated query shown in FIG. 13b. Thus, per the view with mask definition in FIG. 12, the mask columns (mc) are: MD_ID 1301, PT_ID 1303, and VST 1305. Each mask column values (mv) in this case are all NULL. The mask predicate is MD_ID=user_id. The corresponding CASE statements 1302-1306 are shown in the rewritten query of FIG. 13b.

An advantage of the foregoing algorithm is that it can be easily implemented as an extension of existing view functions. However, we also have to consider the following situations:

selection conditions on mask columns

mask columns on group keys or aggregation functions

mask conditions having external column references

query rewrite algorithm for subqueries

Each situation presents its own challenges. We will describe each situation in the following sections.

A. Selection Conditions on Mask Columns

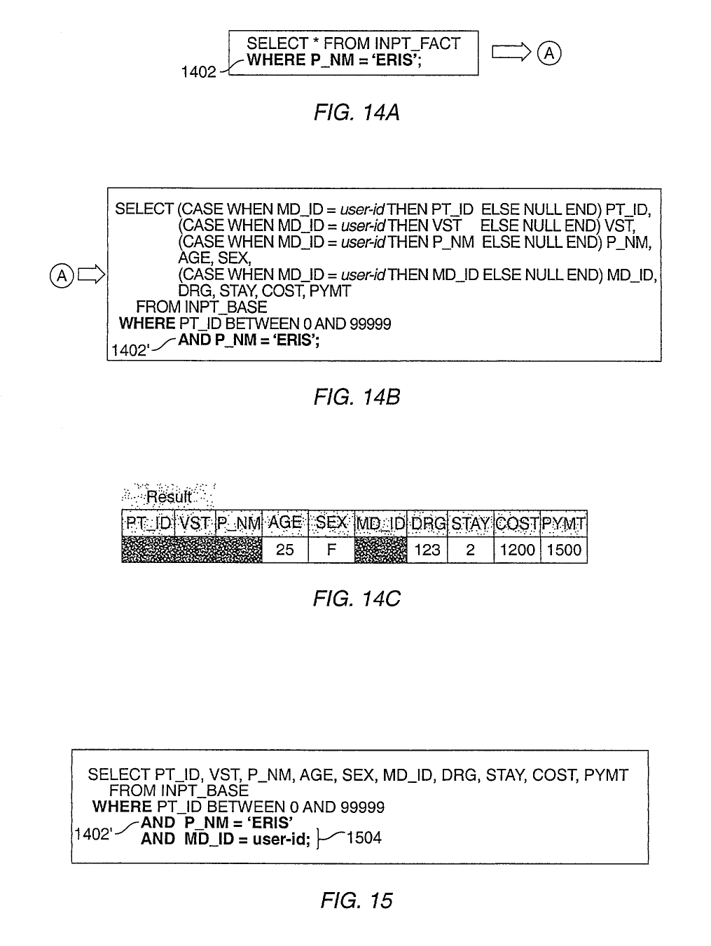

Referring to FIGS. 14a -14c, and 15, we show some restrictions for selection conditions on mask columns, since it may break a mask; i.e. compromise the mask feature thereby permitting unauthorized access to secured data. There are two kinds of selection conditions to consider: One is a condition on a single relation. The other selection condition which can break a mask is a select condition between multiple relations. We call these conditions a “selection condition” and a “join condition,” respectively.

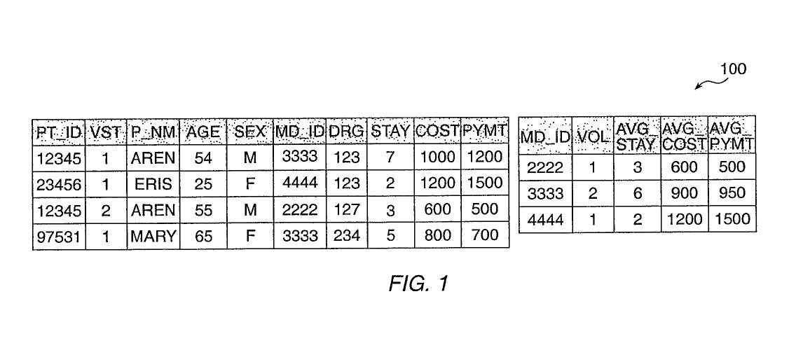

To avoid breaking the mask, selection conditions on mask columns are prohibited. A user can easily get invisible data by adding a selection condition on mask columns. For example, a physician X whose MD_ID is 3333 should not have access the data of ERIS's privacy data (see INPT_BASE table 100, FIG. 1), since physician X did not take care of her admission. For instance, suppose physician X issues the SQL statement shown in FIG. 14a, containing a WHERE-type selection condition 1402. The SQL statement will be translated per PROCESS 1 according to the view definition shown in FIG. 12 to produce a new query shown in FIG. 14b, which contains the selection condition 1402′ taken from the original query of FIG. 14a. Consequently, the physician X obtains the result shown in FIG. 14c, revealing the value of the mask column P_NM to be ‘ERIS’, which should have been masked out.

In accordance with the present invention, to avoid breaking the mask in the foregoing scenario, if there is a selection condition related to a mask column, the mask condition predicate is AND-concatenated to the selection condition, instead of translating the mask column predicate into a CASE expression. Thus, the following processing occurs:

Process 2

If a selection condition C contains a condition on the mask column mc whose mask predicate is mp, the rewritten query QR(σ_{C}(R)) becomes σ_{C&mp}(R).

By applying PROCESS 2, the original SQL statement in FIG. 14a is translated into the SQL statement in FIG. 15. In this case, no row is selected and ERIS's name can be protected. Note the AND-concatenation 1504 of the mask condition (predicate) and the selection condition 1402′ as shown in FIG. 15.

HAVING conditions used in conjunction with a GROUP BY operation are treated as selection conditions. That is, if there is a HAVING condition on one or more mask columns used in a GROUP BY operation, the mask condition predicate will be AND-concatenated to the selection condition. Similarly, if there is a mask column in an ORDER BY clause, the mask condition predicate is added to the selection condition, since a determined user can by trial and error guess the value of the mask column based on unmasked values of the neighborhood rows.

We assume that the original view defined by a view with mask is inference free if we do not apply any conditions and/or aggregations on the view. A relation R is inference free if original values of mask columns in R cannot be inferred from unmasked column values or mask values for those mask columns. Thus, the original values of PT_ID and P_NM (see FIG. 1) cannot be inferred from the other column values such as AGE, SEX, and DRG nor from the mask value that is NULL in the case of the view definition in FIG. 12. The following theorem and proof show that the above query rewrite semantics for selection conditions preserves the inference-free property:

Theory: Inference-free Preservation for Selection Conditions

If relation R is inference free, QR(σ_{C}(R)) is also inference free, where C is a selection condition on R and QR( ) is a query rewrite function for a view with mask.

Proof: If we can infer the original value of a mask column mc whose mask condition predicate is mp, the selection condition C must contain the condition on a mask column. Because relation R is inference free, we cannot infer the original values of mask columns even if we can see all values of the unmasked columns. On the other hand, if the selection condition C contains a condition on the mask column mc, QR(σ_{C}(R)) is translated into σ_{C&mp}(R). Then the result does not include any rows whose mask column mc is invisible. Therefore, we cannot guess the original value of the mask column from the result of the query.

Even though the default semantics of the selection condition on mask columns is restricted per PROCESS 2, a user can define WHERE PRED ALL in the pred_const clause (1107, FIG. 11). If WHERE PRED ALL is defined on a mask column, the query translator rewrites the column according to PROCESS 1. Note that this permission may lose the inference-free property, while it is the view designer's responsibility.

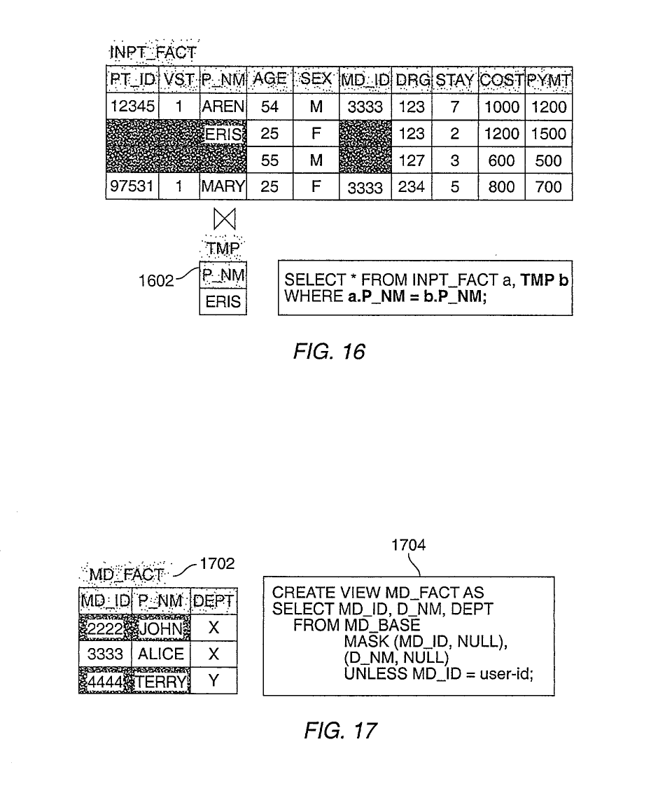

Another way of breaking the mask is through the use of a join condition. A join condition is a kind of a selection condition. Consequently, it should be processed in the same way as other selection conditions. If we allow using a join condition without any restrictions, a user can break the mask in the following way: First, a temporary table TMP 1602 is created which includes the column P_NM. Assuming patient ERIS is the target, the user would enter the value ‘ERIS’ into the P_NM column in the TMP table. The SQL statement in FIG. 14a is rewritten into the SQL statement 1610 shown in FIG. 16, which includes a join operation using the P_NM column as the join key. The result shown in FIG. 14c is thereby obtained because ‘ERIS’ is common to the TMP table and to the INP_FACT view of FIG. 12. Therefore, further in accordance with the invention, if a selection condition includes a JOIN operation, the selection is restricted per PROCESS 2 during the rewrite.

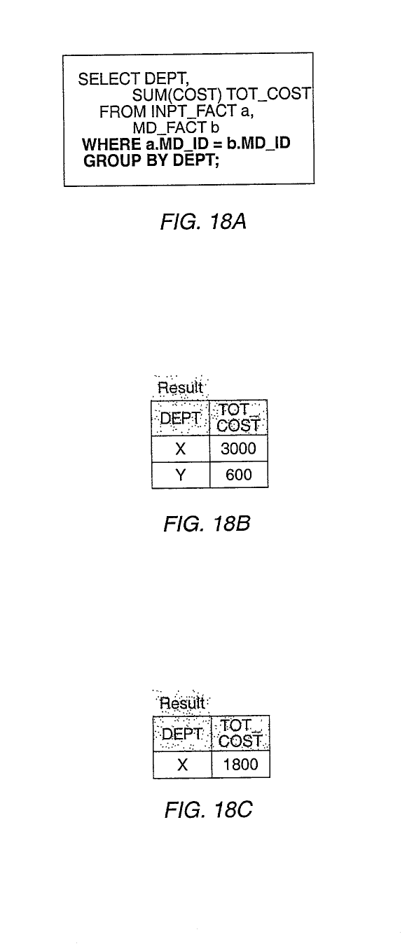

However, there is sometimes a need to join a fact table with reference tables which involve mask columns. Referring to FIG. 17, for example, assume that there is an MD_FACT view 1702 that has the following columns: MD_ID, D_NM, and DEPT. FIG. 17 shows the MD_FACT view and its view definition 1704. Since the column DEPT is not a mask column, a user should be able to get a total cost grouped by each department. FIG. 18a and FIG. 18b show the SQL statements that a user wants to execute and the expected result. However, if we restrict join conditions between INPT_FACT and MD_FACT, a user MD_ID=3333 will get a different result shown in FIG. 18c.

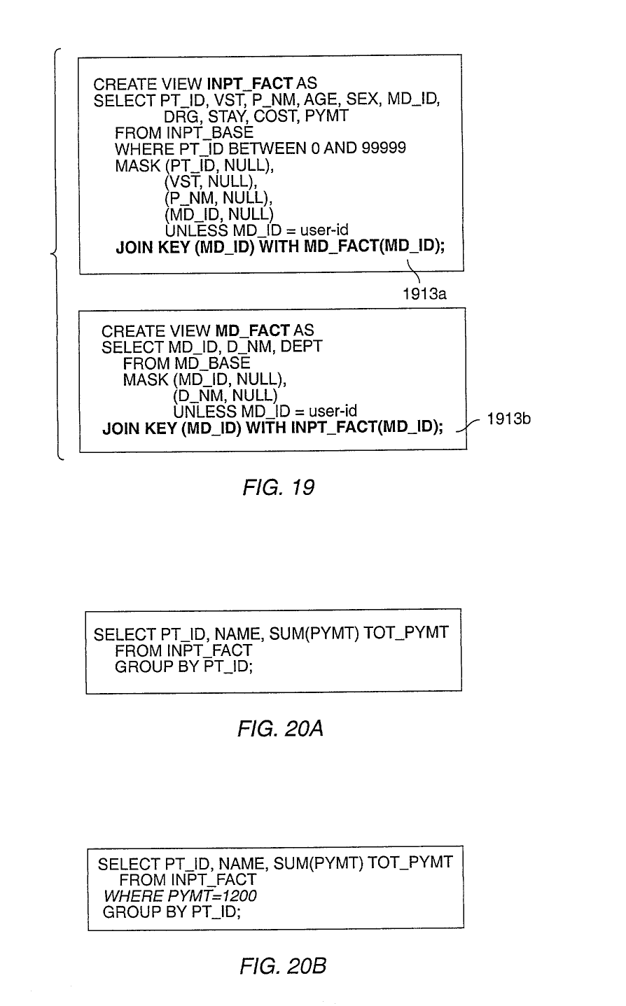

To solve this issue, a view with mask according to the invention includes a join_prmt clause (1113, FIG. 11) so that a user can declare a join permission for mask columns. A join condition is permitted if all mask columns in the join condition expression have join permission with all other columns in the expression, except between the columns in the same view or table. For example, FIG. 19 shows the view with mask definitions for INPT_FACT 1902 and MD_FACT 1904 having join permission clauses 1913a and 1913b, respectively. These clauses permit the execution of a JOIN operation between MD_FACT and INPT_FACT using MD_ID as a join key.

Observe that if the view definition for view with mask INPT_FACT 1902 is defined first, a compilation error will occur, since the definition of the view with mask MD_FACT 1904 will not have yet declared. The database system must provide for recompilation of a view definition due which is invalid due to referencing a yet to be defined view. Also, a view designer is responsible for maintaining the inference-free property for the relation, R_{J}:

R_{J}=JOINⱼₖ(R_{1,} R₂),

if he/she wants to give a join permission between R₁ and R₂ with a join key,jk.

B. Mask Columns on Group Keys or Aggregation Function

Referring to FIGS. 20a and 20b, we show how a mask can be broken by queries having aggregations. There are two cases that we should consider: (1) GROUP BY operation with mask columns as a group key and (2) aggregation functions on mask columns, e.g., sum, average, min/max, and so on. We need to make a restriction to use a mask column as a group key to avoid breaking a mask. As for the aggregation functions on mask columns, we will apply restriction-based techniques that have been proposed in statistical databases.

The GROUP BY operation using a mask column as a group key may give a different group key value. For example, if a physician whose MD_ID is 3333 issues a query in FIG. 20a, the mask predicate of PT_ID returns a different value for AREN's data. Consequently and unintentionally, the physician will be able to see the PT_ID for the first visit but not for the second visit. In such a case, it seems that we only have to return a mask value as a group key value for this group. However, even if we return mask values for this group we can easily break a mask for AREN's second visit by issuing the query shown in FIG. 20b. Since AREN's first visit is the only data whose PYMT is 1200, we can determine the group key value whose TOT_PYMT value is 1200 smaller than the original SQL statement. Therefore we can find that the third row whose PYMT is 500 is AREN's data.

Even though there are a lot of data, we can color the rows by each GROUP BY operation using a similar attack method. Therefore, if a group contains a mask column as a key and the group has at least one row whose mask column is visible, the mask column for other rows in the group is also visible. Thus, the following procedure is used to rewrite queries having mask columns on group keys:

Process 3

If a mask predicate mp is not functionally dependent on a set of group keys, the query, G_{{gl, . . . gn}}(R) is translated into G_{{gl, . . . , gn}}(σₘₚ(R)), where G_{{gl, . . , gn}}(R) means GROUP BY operation on R using {gₗ, . . . , gₙ} as a group key. If mp is functionally dependent on group keys, the mask column mc is translated in accordance with PROCESS 1.

We can calculate a functional dependency for a mask predicate mp by checking whether all referenced variables are covered by the set of group keys. In the case of previous example, the variable of the mask predicate for PT_ID is MD_ID, therefore the mask predicate is not functionally dependent on group column PT_ID.

Recall from above the introduction of the term “inference-free against coloring.” This term is defined as: a relation R is inference-free against coloring, if R is inference-free and original values of mask columns in R cannot be inferred even if R is grouped by GC such that:

GC=_{{gl, . . . , gn/gi} is not a mask column or _{gi} is a mask column whose mask predicate is functionally dependent on _{{gl, . . . gn}}}

This definition means that we cannot infer the group key value based upon the rows belonging to the group. For example, the physician whose MD_ID is 2222 should not be able see the other physician's MD_ID, while he/she can find that the first row and the last row in FIG. 2 have the same MD_ID. The inference-free against coloring property ensures that a physician cannot infer the value of the other physician's MD_ID in such cases (i.e., the physician (MD_ID=2222) cannot guess the MD_ID of the first row, the second row and the last row in FIG. 2). The following theorem states that processing in accordance with the invention preserves the property of inference-free against coloring for GROUP BY operations.

Theory: Inference-free against coloring preservation for GROUP BY operations

If relation R is inference-free against coloring, QR(G_{{gl, . . , gn}}(R)) is also inference-free against coloring, where {_{gl, . . . , gn}} is a set of group key on R and QR( ) is a query rewrite function for a view with mask.

Proof: If {_{gl,. . . , gn}} contains a mask column gᵢ whose mask predicate is mp, the original query G_{{gl, . , gn}}(R) is translated into G_{{gl, . . . , gn}}(σₘₚ(R)). Since σₘₚ(R) filters out all rows whose gᵢ column is masked, the mask column gᵢ no longer becomes a mask column. Therefore G_{{gl, . . . , gn}}σₘₚ(R)) keeps the inference-free against coloring property.

Even though the default rule for using a mask column as a group key is described in PROCESS 3, a user can define GROUP KEY in the gkey_const clause (1109, FIG. 11). If GROUP KEY is defined on a mask column, then the query rewrite of PROCESS 4 is applied, instead of PROCESS 3. Note that the PROCESS 4 query rewrite causes breaking a mask; however, it is within the view designer's scope of responsibility to avoid this:

Process 4

Replace the mask column mc whose mask predicate is mp and whose mask value is mv by the following CASE expression:

(CASE WHEN COUNT(*)=COUNT(CASE WHEN mp THEN 1 ELSE NULL END) THEN mc ELSE mv) [mc]

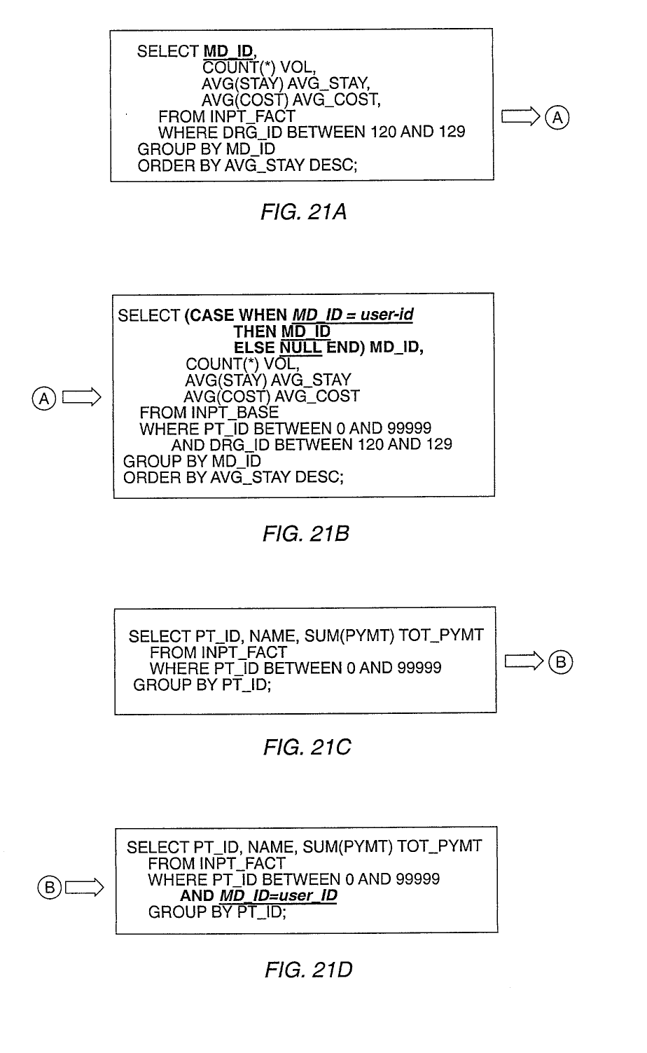

FIGS. 21a -21d, the query shown in FIG. 21a is translated into the query in FIG. 21b, since the mask predicate is functionally dependent on the group key, MD_ID. The query in FIG. 21c is translated into the query in FIG. 21d, since mask predicate is not functionally dependent on PT_ID.

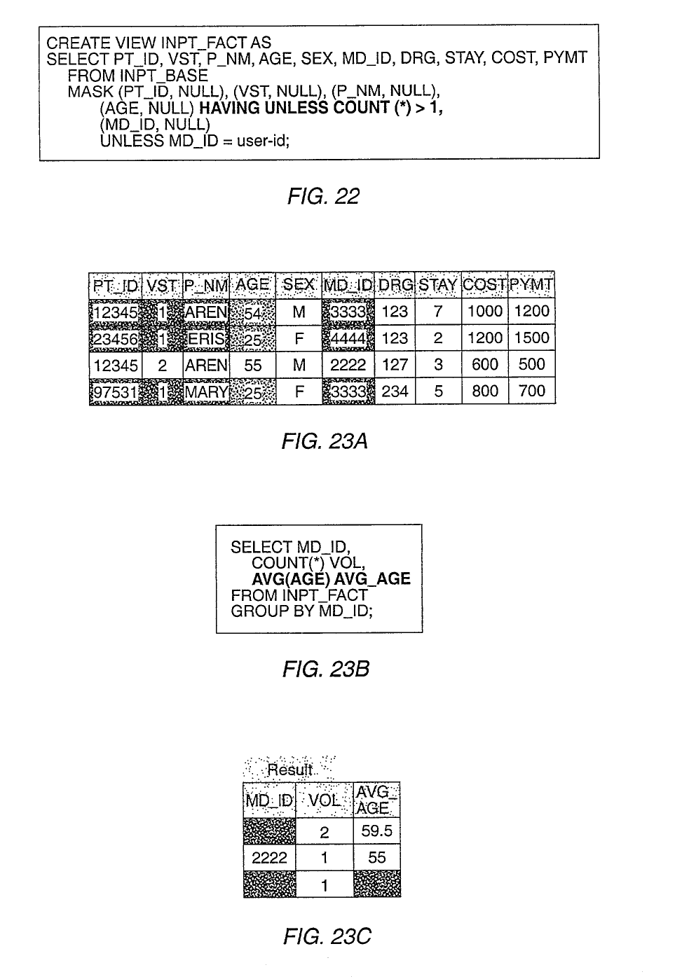

Similar to the restriction-based access control of the statistical database, a mask with view has an access control for aggregation functions, such as SUM, AVG, MAX, MIN and COUNT. An access control rule for aggregation functions is defined based on the condition of the source data set. For example, a result of the aggregation function should be masked unless the population of the source data set is more than 1. To describe access control rule on aggregation functions, we propose an aggregation mask condition using aggr_const clause (1111, FIG. 11). FIG. 22 shows an example of the view definition that has an aggregation mask condition on AGE. The condition means that the aggregation result will be replaced with a null value unless the number of rows in the group is more than 1.

Note that the aggregation constraints will give the same level of security protection as the restriction-based access control for statistical database systems. Therefore, a user may solve masked values by using as technique such as discussed in Chin, F. Y., entitled “Security in Statistical Databases for Queries with Small Counts,” ACM Trans. Database System, 3, I (March 1978), pp. 92-104, and other similar technologies.

Note that if a user can see all AGE values of a group, the user should have the real aggregation result even if the number of the rows in the group does not exceed 1. For example, a user whose MD_ID is 2222 should have a result shown in FIG. 23c when the user issues a query in FIG. 23b. The number of the data in the group MD_ID=3333 is two, therefore the AVG(AGE) for this group is visible (see in the first row of the expected result). Since the other groups do not have more than 1 data, the AVG(AGE) should be masked. However, AREN's second admission data is visible for a physician whose MD_ID is 2222, because the AVG(AGE) for the group of MD_ID=2222 is also visible. In conclusion, the result of an aggregation function is visible, when: (i) the source data set satisfies the aggregation mask condition, or (ii) all values in the group are visible. Note that the default the aggregation mask condition is FALSE to avoid returning the real value of the aggregation result for mask columns.

PROCESS 5 shows a query rewrite method for aggregation functions. An aggregation mask condition is used as a condition of the WHEN clause, while the column mask condition is also used to check whether all of the rows satisfy the mask condition or not.

Process 5

(1) For each aggregation function fn( ) on a mask column mc whose mask value is mv and whose aggregation mask condition predicate is ap and mask condition predicate is mp, apply (2).

(2) Replace each aggregation fn(mc) as following CASE expression:

(CASE WHEN ap OR COUNT(*) = COUNT(CASE WHEN mp THEN 1 ELSE NULL END) THEN fn(mc) ELSE mv END)

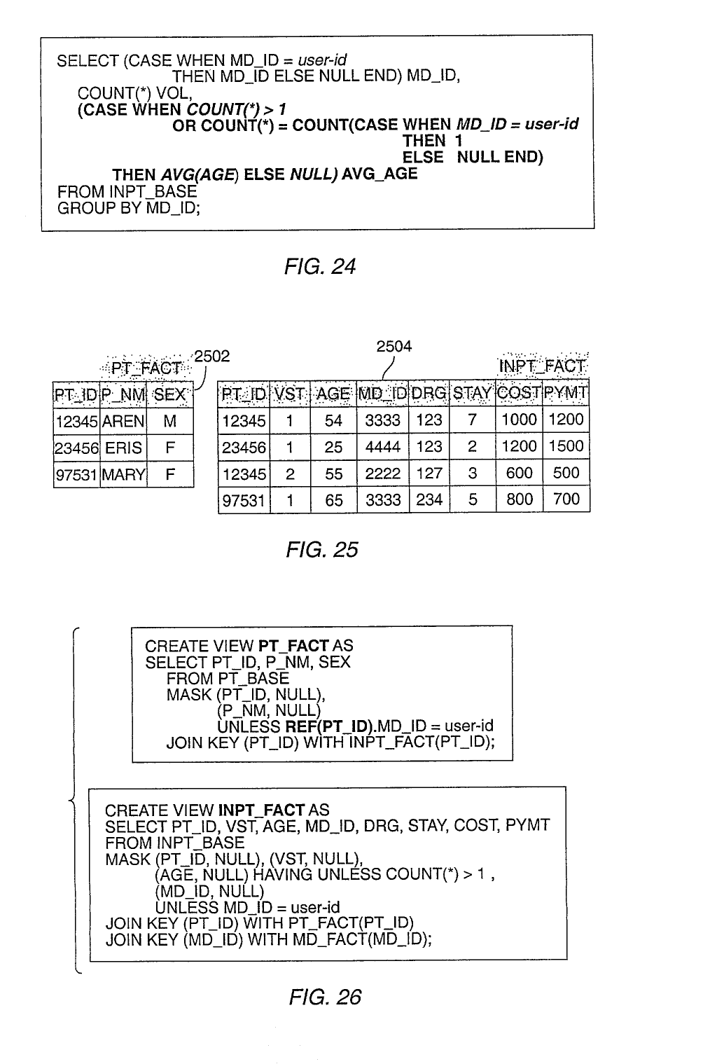

FIG. 24 shows the translated SQL statement shown in FIG. 23b by PROCESS 5, which will give the result of FIG. 23c.

C. Mask Conditions having External Column References

It is noted that the view INPT_FACT in FIG. 23a is not normalized, since it contains redundant patient information, such as PNM and SEX. We usually design views shown in FIG. 25, which have a PT_FACT view 2502 and a separate INPT_FACT view 2504. We assume that there are also normalized base tables, PT_BASE and INPT_BASE, not shown.

To enforce the same cell-level access control as the previous view in FIG. 22, the PT_FACT view 2502 needs to refer to the MD_ID column in the INPT_FACT view 2504. Because the PT_ID and P_NM columns are masked based on the MD_ID of each patient admission, we cannot decide whether or not the columns should be masked based on only PT_ID in the PT_FACT view. Note that P_NM for the first row of the INPT_FACT view is visible for the physician whose MD_ID is 3333, but is not visible for the physician whose MD_ID is 2222, even if the physician treated AREN's second admission.

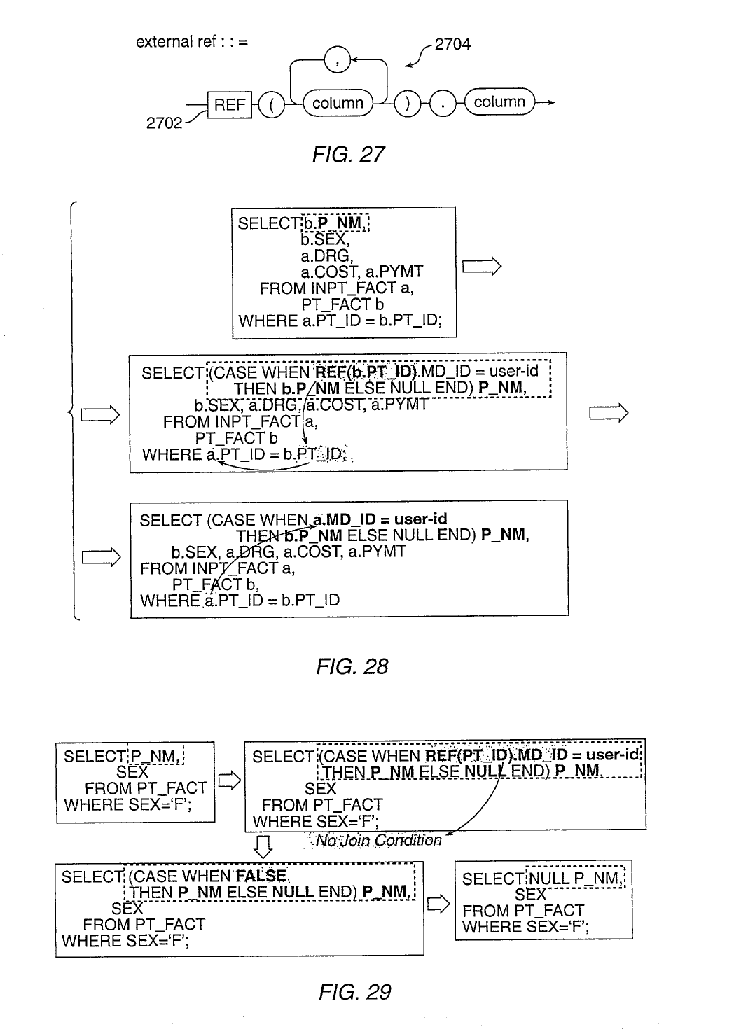

In accordance with the present invention, a notation for external column references is introduced to solve this problem. FIG. 26 shows view definitions for the views in FIG. 25. The mask condition predicate REF(PT_ID).MD_ID=user_id uses an external column reference. REF(PT_ID) is replaced by a table or view that have a join condition with a join key, PT_ID. FIG. 27 shows a syntax diagram of an external column reference. An external table or view is identified by the REF( ) expression 2702 with a set of parameters 2704 that represent join keys. The column followed by the REF( ) expression represents a column that the mask condition refers.

The external column reference should be unified to a single table or view during query rewriting without any conflict. There are two cases where the unification fails:

(1) No table or view matched

(2) Multiple tables or views matched

In these cases, the predicate term including the external column reference will be replaced with FALSE. Note that it does not mean that the mask condition predicate immediately returns FALSE. For example, if the predicate term is OR-concatenated with other predicate terms, the mask condition may return TRUE.

FIG. 28 shows the case where the unification of an external column reference succeeds. The b.P_NM in the original SQL statement will be translated into a CASE expression that includes REF(b.PT_ID).MD_ID. The external reference identifier REF(b.PT_ID) searches the join condition that has a join key, b.PT_ID, and it finds a target relation a. Consequently, REF(b.PT_ID).MD_ID is replaced with a.MD_ID.

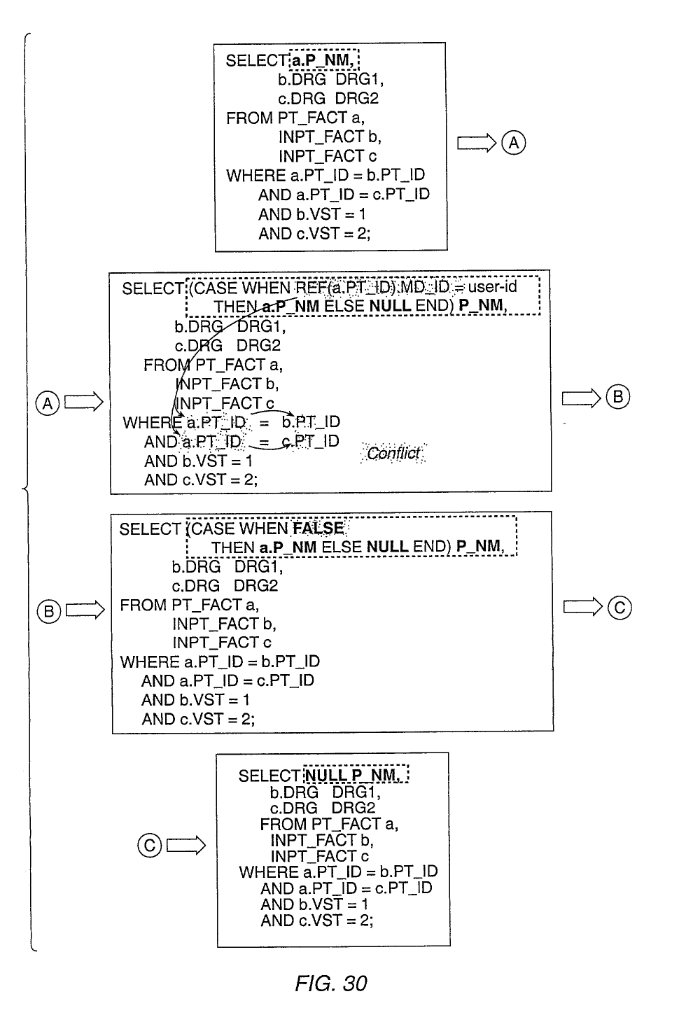

Two cases where the unification fails are shown in FIG. 29 and FIG. 30. In the first case in FIG. 29, since the original query does not have any join condition, there is no matching relation for REF(PT_ID). Therefore, the predicate term, REF(PT_ID).MD_ID=user_id, is replaced by FALSE, and then the execution result of the translated SQL statement does not have any visible P_NM. In the second case in FIG. 30, the external column reference expression have two unification candidates, b and C. Therefore, the predicate term is replaced by FALSE and therefore no P_NM value will be returned as a result.

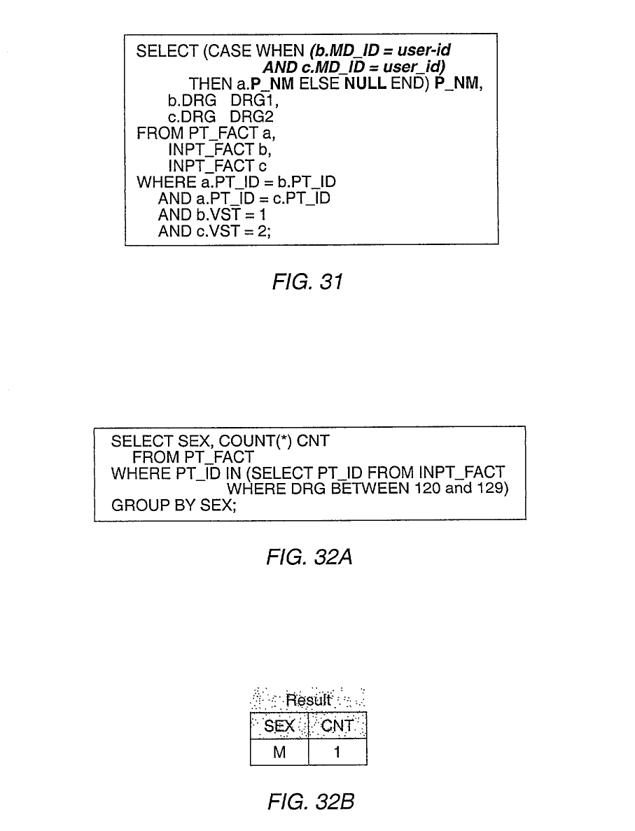

The query translation policy described above does not allow accessing P_NM even if the same physician processed both his/her first and second admission. If we want to allow accessing P_NM in such a case, the original SQL statement should be translated as in FIG. 31. In this case, when the query translator finds a conflict of external column reference, it duplicates the predicate terms, and AND-concatenates them.

D. Query Rewrite Algorithm for Subqueries

A query may include a subquery. There are two ways to apply a view with mask to a query having a subquery:

(1) Apply masks to the final result of the query.

(2) Apply masks to each subquery.

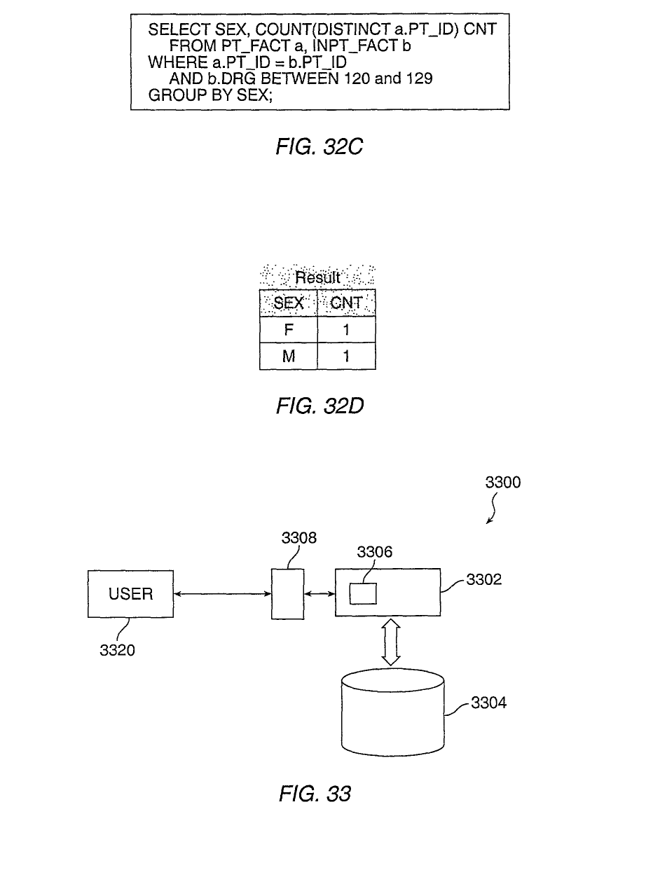

In order to apply the first solution, we need to expand all subqueries to check selection conditions on mask columns and aggregation functions. However, it is difficult for end-users to predict the expansion result of the query, therefore, users sometimes may have a different result from what they expected. Therefore, we choose the second solution to keep the semantics as simple as possible. For example, the mask for INPT_FACT.PT_ID is applied for the subquery in the query in FIG. 32a, therefore the subquery returns the following PT_ID values: PT_ID=12345 for the first row of INPT_FACT, and PT_ID=NULL for the second and third row of INPT_FACT. (The fourth row will be filtered by the condition DRG BETWEEN 120 AND 129.) Since the IN predicate in the main SELECT clause is recognized as a join condition between PT_FACT and INPT_FACT using PT_ID as a key, the query returns the result in FIG. 32b.

FIG. 32c shows a similar query that has no subquery. Since PT_ID is the only mask column in this query, and it is used to join PT_FACT and INPT_FACT, which is permitted in the view definitions, the execution result of this query will be FIG. 32d.

PROCESS 6 shows a query rewrite algorithm for a view with mask, which contains all of above discussions.

Process 6

(1) For each SELECT clause, do (2)-(15).

(2) For each selection predicate on mask columns, do (3)-(8). Note that ORDER BY and HAVING clause is treated as a kind of selection predicates.

(3) If the predicate does not contain a mask column, then check next predicate.

(4) For each mask column in the predicate, do (5)-(7).

(5) If the predicate have WHERE PRED ALL permission, then check the next column.

(6) If there are other columns in the predicate and the mask column has join permission with all of the other columns in the predicate, then check the next column.

(7) Otherwise add the mask predicate mp as a filtering conditions, and then check the next column.

(8) Check the next predicate.

(9) For each group column gc in a set of group keys, do (10)-(12)

(10) If gc is not a mask column or the mask predicate is functionally dependent on a set of group keys, then check next column.

(11) If gc does not have GROUP KEY permission, then apply PROCESS 3. Otherwise apply PROCESS 4.

(12) Check next group column.

(13) For each mask column, apply PROCESS 1.

(14) For each aggregation function fn( ) on a mask column mc, apply PROCESS 5.

(15) For all external column references in mask conditions, unify them. If unification fails, replace the predicate term that contains the external column reference into FALSE.

The foregoing methods are typically effectuated on computer system. For example referring to the illustrative example shown by the block diagram of FIG. 33, a database system 3300 is typically provided on a computer subsystem 3302 having a central processor and system memory. A mass storage subsystem 3304 provides storage for the data comprising the database. The computer subsystem provides an operating environment (commonly referred to as an operating system, e.g., UNIX) to allow a database software subsystem 3306 to access the hardware components of the system to provide the required database functions. A user 3320 interacts with the database system via any of a number of known communication links, whether directly connected or remotely accessed.

In accordance with the invention, additional software 3308 is provided which performs the query rewrite (translation) capability discussed above to produce a query that generates results consistent with the user-specified view with mask definition. In another embodiment of the invention, the existing database software subsystem 3306 is modified to with software components which perform post-processing of a query result to produce a result according to the mask conditions of the view with mask definition.

The block diagram of FIG. 33 is a highly simplified view, intended to illustrate the various hardware and software that belong in a modem database system and leaving out specific implementation details that are not germane to the disclosure of the invention. It is understood that anyone of ordinary skill would be able to provide the needed details to practice the invention.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Although the present invention has been described in terms of specific embodiments, it should be apparent to those skilled in the art that the scope of the present invention is not limited to the described specific embodiments.

The specification and drawings are, accordingly, to be regarded in an illustrative rather than a restrictive sense. It will, however, be evident that additions, subtractions, substitutions, and other modifications may be made without departing from the broader spirit and scope of the invention as set forth in the claims.

What is claimed is:

1. A method for accessing information, said information having an organized structure, the method comprising:
receiving a view definition including at least one mask condition, said mask condition being associated with first information contained in said information;
receiving a query;
rewriting said query based on said mask condition to produce a new query;
executing said new query to access said information; and
if said query would produce a result containing some of said first information, then producing a result which may or may not contain said first information, based on said mask condition.

2. The method of claim 1 wherein said information is organized into plural tables comprising plural columns, at least a first of said columns being associated with said mask condition, wherein said producing a result includes either retrieving information from said first column or using a default information, depending on said mask condition.

3. The method of claim 1 wherein said information includes plural tables having columns, access to data contained in one or more of said columns being based on said mask condition, wherein if said query includes a selection condition on said one or more columns then said new query includes a logical combination of said selection condition and said mask condition.

4. The method of claim 3 wherein said selection condition is AND-concatenated with said mask condition.

5. The method of claim 3 wherein said selection condition includes a join operation.

6. The method of claim 3 wherein said selection condition includes at least one aggregation operation.

7. The method of claim 6 wherein said selection condition further includes at least one group by clause.

8. The method of claim 1 wherein said query includes one or more sub-queries.

9. The method of claim 1 wherein said mask condition includes an information class and a mask predicate, said information class having an associated mask value, information that is categorized under said information class being referred to as masked information,
wherein said new query is produced such that if said mask predicate evaluates to a first logic value then an attempt to access said masked information produces a result which comprises said masked information,
wherein said new query is produced such that if said mask predicate evaluates to a second logic value then an attempt to access said masked information produces a result which comprises said mask value in place of said masked information,
wherein access to said masked information is based on said mask condition.

10. The method of claim 9 wherein said information is organized as plural tables, said view comprising portions of one or more of said tables, said information class being a column in a table of said view.

11. The method of claim 1 wherein said organized structure of said information is a relational database.

12. The method of claim 11 wherein said query is a form of SQL (structure query language).

13. In a database comprising information organized as plural tables, each containing data values arranged in table rows and table columns, a method for retrieving said information comprising:
providing one or more mask values;
generating at least one view comprising view rows and view columns corresponding to portions of some of said table rows and tables columns;
receiving a query;
executing said query to produce a first result by retrieving information from said view rows and view columns; and
replacing some data values in said first result with said mask values to produce a final result.

14. The method of claim 13 further including providing at least one mask condition associated with one or more of said view columns, wherein if a data value belongs to said one or more of said view columns then said replacing is made depending on said mask condition for said data value.

15. The method of claim 13 wherein said providing includes receiving a view definition having a mask condition, said mask condition includes one or more column identifiers and a mask predicate, said one or more column identifiers being associated with said one or more mask values, information that is categorized under said one or more column identifiers being referred to as masked information,
wherein if said mask predicate evaluates to a first logic value then masked information contained in said first result appears in said final result;
wherein if said mask predicate evaluates to a second logic value then said replacing includes replacing masked information contained in said result first result with one of said one or more mask values.

16. The method of claim 13 wherein said organized structure of said information is a relational database.

17. The method of claim 16 wherein said query is a form of SQL (structure query language).

18. A computer-readable medium containing program instructions for controlling a computer to access information, said information having an organized structure, the computer-readable medium comprising:
first program instructions configured to receive a view definition including at least one mask condition, said mask condition being associated with first information contained in said information;
second program instructions configured to receive a query;
third program instructions configured to rewrite said query based on said mask condition to produce a new query; and
fourth program instructions configured to execute said new query to access said information,
said fourth program instructions further configured such that said new query will generate a result which may or may not contain said first information on the basis of said mask condition, if said query would produce a result containing some of said first information.

19. The computer-readable medium of claim 18 wherein said information is organized into plural tables comprising plural columns, at least a first of said columns being associated with said mask condition, wherein said new query includes either retrieving information from said first column or using a default information, depending on said mask condition.

20. The computer-readable medium of claim 18 wherein said information includes plural tables having columns, access to data contained in one or more of said columns being based on said mask condition, wherein if said query includes a selection condition on said one or more columns then said new query includes a logical combination of said selection condition and said mask condition.
